(19) United States
(12) Patent Application Publication
(10) Pub. No.: US 2009/0026751 A1
(43) Pub. Date: Jan. 29, 2009

(54) PROTECTIVE STRUCTURE FOR AN ARTICLE, IN PARTICULAR A DOCUMENT

(75) Inventors: Sandrine Rancien, La Murette (FR); Pascal Marlin, Coulommiers (FR)

Correspondence Address: OLIFF & BERRIDGE, PLC, P.O. BOX 320850, ALEXANDRIA, VA, 22320-4850, US

(73) Assignees: ARJOWIGGINS, Issy Les Moulineaux (FR); ARJOWIGGINS SECURITY, Issy Les Moulineaux (FR)

(21) Appl. No.: 12/142,344

(22) Filed: Jun. 19, 2008

Related U.S. Application Data
(63) Continuation of application No. PCT/FR2006/051420, filed on Dec. 22, 2006.

(30) Foreign Application Priority Data
Dec. 22, 2005 (FR) 05 54041

(51) Int. Cl. B42D 3/00

(52) U.S. Cl. 281/29

(57) ABSTRACT

The present invention relates to a protective structure for an article such as a document, the article comprising: at least two panels connected together by a fold zone; and at least one electronic device enabling data to be exchanged without contact, or at least one compartment arranged to receive at least one element including such an electronic device; the protective structure comprising: at least one fold zone enabling the structure to accompany folding of the article; at least one electromagnetic screen including at least one portion that is substantially transparent so that information that appears on the article can be seen through said substantially transparent portion of the protective structure; and at least one holding element arranged to hold the article on the protective structure in releasable manner; the structure being arranged to be capable of taking at least one configuration in which the structure is put into place on the article and the electromagnetic screen opposes contactless reading and/or writing of the electronic device.

The present invention provides in particular a protective structure for an article, in particular a document.

In general, there exists a need for an article that includes an electronic device capable of exchanging data without contact by electromagnetic means, in particular a device of the radio frequency identification device (RFID) type, to be protected against attempts at reading and/or writing data without the knowledge of the bearer of the article by using a reader that is sufficiently powerful.

By way of example, fraudulent access to the data on the electronic device can make it possible illegally to verify the identity of a person, to access remotely personal data for fraudulent use, to track the movements of a person, or to establish a list of that person's tastes and habits in order to build up a personal profile.

Furthermore, certain countries have adopted the so-called “biometric” passport that includes an electronic chip device storing the bearer's photograph and fingerprints.

French patent application FR 2 863 748 discloses a passport that includes, on a first of the panels of its cover, a transponder that is formed by an electronic module connected to an antenna. A second panel of the cover, or one of the leaves (sheets) of the booklet, is provided with an element for passively masking the antenna of the transponder in order to disturb contactless reading of data stored by the electronic module. The masking element is defined by an aluminum sheet and it covers at least part of the transponder antenna when the passport booklet is closed. The masking element may be formed by a label stuck onto the cover or onto a leaf of the passport. That French patent application FR 2 863-748 also describes a protective case for receiving a smart card, the case having two panels that can be folded one onto the other. One of the panels includes a masking element for making it impossible to read the card when the panels of the case are folded one onto the other.

International application WO 2005/119586 discloses a security document including a transponder and a screen preventing protected information from being read remotely when the security document is closed.

Patent application US 2005/0274794 describes a support for security documents that includes an electromagnetic screen preventing unauthorized reading of information that needs to be protected.

Patent application JP 2005/30142 discloses a case for a passport including an RFID type chip and two electromagnetic shields.

International application WO 2005/062246 describes a passport with a cover that includes an electromagnetic screen that prevents information that needs to be protected from being read when the passport is closed.

Patent application JP 2004-188215 describes a case comprising firstly a support for receiving a smart card and secondly a flap that can be folded onto the support. The support and the flap define a screen preventing contactless reading of data contained in the smart card.

Patent application JP 11-348471 describes a booklet including an electronic module carried by one of the panels of the cover or by one of the leaves of the booklet. The front panel of the cover of the booklet may define an electromagnetic screen and the electronic module may be carried by the rear panel. Under such circumstances, it is possible to read the electronic module when the booklet is opened. The cover made in that way presents front and rear panels that are asymmetrical, because of differences in thickness and in composition, which can make fabrication of the booklet relatively complex and expensive and can spoil its appearance. In a variant, the electromagnetic screen is formed both on the front and the rear panels, and the electronic module is carried by a leaf of the booklet. In order to read the chip, it is necessary to fold the panels of the cover backwards, and in the long run that can damage the hinge interconnecting the front and rear panels of the cover. Finally, the relatively complex structure of the cover forming the electromagnetic screen can affect the durability of the booklet.

Application FR 2 663 445 describes an electronic card including an electronic circuit carried by a plate placed in a generally flat box. Two conductive layers are stuck onto the outside of the box, which layers may present a thickness of the order of one-hundredth of a millimeter and serve to protect the electronic circuit against disturbances due to electrostatic discharges. Protective sheets are subsequently stuck onto the conductive layers.

The invention seeks in particular to make it simpler to protect an article including an electronic device against a fraudulent attempt at reading and/or writing data stored in the electronic device.

Thus, in one of its aspects, the invention provides a protective structure for an article such as a document, the article comprising:
at least two panels connected together by a fold zone; and
at least one electronic device enabling contactless exchange of data, or at least one compartment arranged to receive at least one element including such an electronic device;

the protective structure comprising:
at least one fold zone enabling the structure to accompany folding of the article;
at least one holding element arranged to hold the article removably on the protective structure; and
at least one electromagnetic screen;

the structure being arranged to be capable of taking at least one configuration in which the structure is put into place on the article and the electromagnetic screen opposes contactless reading and/or writing of the electronic device.

By virtue of the electromagnetic screen, the invention makes it relatively simple to protect the electronic device against fraudulent attempts at reading and/or writing data, and it does so in particular without it being necessary to modify the article that is to be protected.

For example, the protective structure of the invention may be made separately from the article that is to be protected, which article may retain its original appearance and/or physical or mechanical characteristics.

Because the protective structure is put into place removably on the article, if the protective structure becomes damaged in use, it may easily be replaced by a new structure.

Furthermore, the protective structure may be arranged to protect the article on which it is placed, e.g. to protect it against mechanical attack, thereby enabling the durability of the article to be increased.

The protective structure may thus be arranged to cover at least part of an outside face of the article when the structure is in place on the article.

The protective structure may include a portion defining the electromagnetic screen, said portion being substantially transparent. A portion is said to be “substantially transparent” when it enables information that appears on an outside face of the article to be visible through the protective structure when said protective structure is in place on the article to be protected.

This can be advantageous in terms of appearance, particularly when the article that is to be protected is a passport having symbols of a gold color on its cover made in a manner that is intended to enhance the image of the country concerned.

The substantially transparent portion may present a light transmission coefficient that is greater than 0.5, in particular greater than 0.7, e.g. being close to 0.8 for daylight.

By way of example, the protective structure may comprise a support made of plastics material, in particular a transparent material, in particular polyester.

Where appropriate, the protective structure may include at least one semireflecting zone.

In an embodiment of the invention, the structure includes at least two panels interconnected by the fold zone.

At least one of the panels of the protective structure may comprise at least a main portion and a flap for forming the holding element that enables at least a portion of a panel of the article to be inserted between said main portion and said flap.

By way of example, the flap may have at least two opposite edges, in particular parallel edges, that are fastened to the main portion of the panel.

Prior to contactless reading and/or writing of data from or to the electronic device with the help of an external read and/or write device, the protective structure may be separated from the article.

After the read and/or write operation, the protective structure is put back into place on the article.

In a variant, the flap is connected to said main portion of the panel in such a manner as to enable the flap to be folded towards or away from the main portion.

In another embodiment of the invention, the holding element comprises at least one element that is fitted to a panel of the protective structure.

By way of example, the holding element comprises at least one resilient element arranged to hold a panel of the article against a panel of the protective structure, the resilient element being in the form of a strip, for example.

In an embodiment of the invention, the electromagnetic screen extends over the entire surface of the protective structure.

Under such circumstances, when the electronic device is carried by one of the panels of the article that is to be protected, the protective structure is separated from the article at the time when data is being read from and/or written to the electronic device.

In another embodiment of the invention, the electromagnetic screen extends over a portion only of the surface of the protective structure.

When at least one of the panels of the protective structure comprises a main portion for covering at least part of an outside face of the corresponding panel of the article, the electromagnetic screen may extend at least over said main portion of the protective structure, for example, and in particular may extend over said main portion only.

When reading data from the electronic device, it is thus possible to leave the protective structure in place on the article that is to be protected, providing the electronic device is carried by a panel of the article that is different from the panel covered by the electromagnetic screen.

By opening the panels of the article, the electromagnetic screen is moved far enough away from the electronic device to avoid disturbing the reading and/or writing of data.

If so desired, the electromagnetic screen may extend over at least the above-mentioned foldable flap, and in particular it may extend only over said flap.

Thus, the electronic device may be carried by a panel of the article that is to be protected, suitable for being sandwiched between the main portion and the flap defining the electromagnetic screen of the protective structure, thus enabling the electronic device to be protected against fraudulent reading and/or writing.

The electronic device may be carried by the portion of a panel of the article that is to be protected that is situated close to the fold zone, or by the portion of a panel of the article that is to be protected that is remote from the fold zone.

By folding the flap defining the electromagnetic screen far enough away from the electronic device, it is possible to proceed with reading and/or writing data from and/or to the electronic device, without it being necessary to separate the protective structure completely from the article.

If so desired, the protective structure may include two foldable flaps, each connected to a main portion of a respective one of two panels of the structure. The electromagnetic screen is formed in particular on these two foldable flaps, e.g. enabling an electronic device carried by a leaf of the booklet to be protected when the booklet is closed. The electronic device is then sandwiched between the two foldable flaps defining the electromagnetic screen.

Where appropriate, the protective structure may include, on at least one of the panels, a holding flap for holding the article, in particular a flap having two opposite edges fastened to the main portion of the panel, and a foldable flap, in particular of area that is greater than the area of the holding flap, the electromagnetic screen being formed at least on the foldable flap.

Where appropriate, the electromagnetic screen may extend simultaneously over the main portion and over the flap of a panel of the protective structure.

The protective structure may comprise at least three panels, e.g. four panels, that are connected together in pairs by respective fold zones.

In an embodiment of the invention, the electromagnetic screen may be formed by a magnetic and/or electrically-conductive material embedded throughout the material of the support.

In a variant, the electromagnetic screen is formed by a magnetic and/or electrically-conductive material that is deposited on a face of the support.

In another variant, the electromagnetic screen is formed by a magnetic and/or electrically-conductive material that defines a core of the support.

The electromagnetic screen may present a variety of shapes and/or dimensions adapted to disturb contactless reading and/or writing when the electromagnetic screen is sufficiently close to the electronic device.

For example, the electromagnetic screen may present an outline that is rectangular, square, or curved, e.g. circular or elliptical. The electromagnetic screen may form a solid pattern. In a variant, the screen may be in the form of a folded-over strip, the strip for example being substantially rectangular or circular. By way of example, the electromagnetic screen may present a grid pattern, if so desired.

The electromagnetic screen may define at least one pattern that contributes to the appearance of the structure, said pattern being constituted, for example, by an alphanumeric character, a symbol, a logo, or a design.

The electromagnetic screen may be formed with the help of at least one of the following elements:
a support, in particular a film, of plastics material rolled or laminated with at least one metal film, e.g. a film of aluminum or of copper;
a support that is metal-plated, in particular by vacuum-plating or by chemical treatment, the support possibly being selected from: a film of plastics material; a paper; a textile; and a non-woven fabric;
a support, in particular of paper or of plastics material filled with an electrically conductive filler such as carbon black or carbon fibers, metal fibers, metal-plated fibers, metal flakes, a metal powder, or with a conductive agent such as salt;
a support made of interlocking yarns, in particular a woven fabric, a knit, a grid, with at least some of the yarns being made of an electrically conductive material, e.g. being made of wire;
a non-woven support comprising conductive fibers, e.g. metal fibers, possibly mixed with synthetic fibers;
a support, in particular a film, presenting a perforated metal structure;
a metal film;
an electrically conductive varnish or paint, e.g. based on copper, nickel, or silver;
an electrically conductive polymer such as polypyrrole, polyacetylen, and polythiophene; and
an electrically conductive adhesive.

The electromagnetic screen may also be formed with the help of at least one of the following elements:
a support, in particular a film, of plastics material rolled or laminated with at least one magnetic film;
a support with a magnetic coating, e.g. deposited under a vacuum or by chemical treatment;
a support, in particular of paper or of plastics material, filled with a magnetic filler such as ferrites;
a support, in particular a film, presenting a perforated structure of magnetic material;
a magnetic film;
a magnetic varnish or paint; and
an adhesive including magnetic particles.

The electromagnetic screen may be formed by carbon nanotubes or by magnetic nanoparticles, for example.

If so desired, the protective structure may include at least one printed zone, or a pattern that is transferred, e.g. by applying pressure and/or heat, or gold-plating, or a label, in particular a label stuck onto a face of the structure.

The structure of the invention may be arranged to be capable of being put into place on a document, in particular a security document and/or a document of value, such as a passport.

In another of its aspects, the invention also provides an assembly comprising:
an article, in particular a document; and
a protective structure as defined above put into place removably on said article.

The article may comprise a booklet, in particular a passport booklet, having a cover that presents two panels.

The holding element of the protective structure may be arranged to hold simultaneously one of the panels of the cover and one or more leaves of the booklet.

By way of example, the electronic device may be carried by a panel of the cover of the booklet or by a leaf of the booklet.

The article may be made up of at least three panels that are interconnected in pairs by respective fold zones.

In another of its aspects, the invention also provides a method of protecting an article, in particular a document, forming part of an assembly as defined above, against an attempt at contactless reading and/or writing of data from or to the electronic device, the method comprising the following step:
putting the protective structure removably into place on the article.

In another of its aspects, the invention also provides a method of contactless reading and/or writing of data from or to the electronic device of an article of an assembly as defined above, the method comprising the following steps:
moving the electromagnetic screen of the electronic device far enough away to avoid disturbing contactless reading and/or writing of data from or to the electronic device, in particular by electromagnetic coupling; and
reading data from the electronic device and/or writing data to the electronic device.
The method may include the following step:
completely separating the protective structure from the article.

In a variant, the method may include the following step:
moving the electromagnetic screen away from the electronic device without completely separating the protective structure from the article, e.g. by folding out a flap of the protective structure and/or by placing the article in a given configuration.

In another of its aspects, the invention also provides an assembly comprising:
an article comprising at least one electronic device enabling data to be exchanged electromagnetically, or at least one compartment arranged to receive at least one element including such a device; and
a protective structure arranged to be capable of taking at least one configuration in which the structure is put into place on the article, and the electromagnetic screen opposes reading and/or writing data from or to the electronic device, the structure including at least one substantially transparent portion defining at least part of the electromagnetic screen in such a manner that the information appearing on the article is visible through said substantially transparent portion of the protective structure.

The article that is to be protected may be selected from at least one of the following elements: an identity card; a visa; a driving license; this list not being limiting.

In a variant and by way of example, the article may be a case including one or more compartments arranged to receive an element including an electronic device, said element being a smart card, for example.

The case may include substantially rigid outer panels, where appropriate.

The article may also be a piece of baggage, such as an attaché case.

In another of its aspects, the invention also provides a protective structure for an article such as a document, the article comprising:
at least two panels connected together by a fold zone; and
at least one electronic device enabling contactless data exchange, or at least a compartment arranged to receive at least one element including such an electronic device;

the protective structure being permanently fastened to the article and comprising:
at least one fold zone enabling the structure to accompany folding of the article; and
at least one electromagnetic screen;

the structure being arranged to be capable of taking up at least one configuration in which the electromagnetic screen opposes contactless reading and/or writing of the electronic device.

The present invention may be better understood on reading the following detailed description of non-limiting embodiments of the invention, and on examining the accompanying drawings, in which:

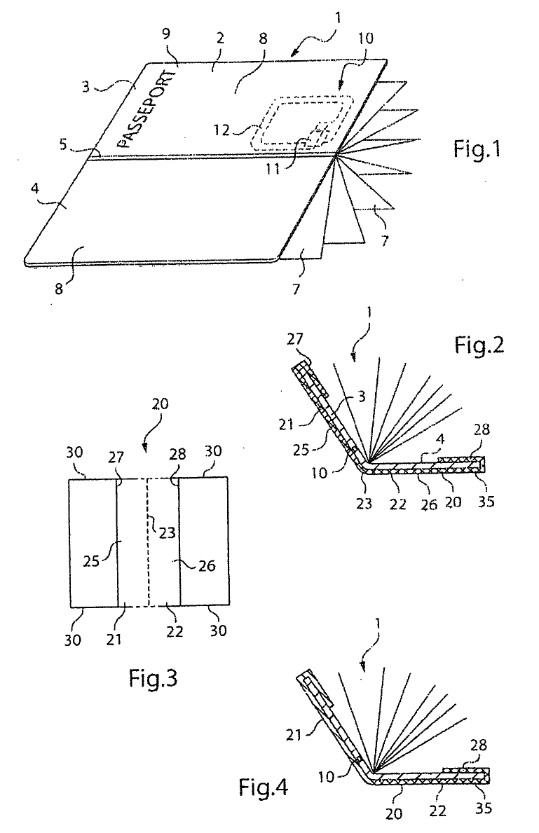

FIG. 1 is a diagrammatic and fragmentary view of a passport;

FIG. 2 is a diagrammatic and fragmentary cross-section view showing a protective structure in accordance with the invention, put into place on the FIG. 1 passport;

FIG. 3 is a diagrammatic and fragmentary view showing the protective structure of FIG. 2 in isolation;

FIGS. 4 to 13 are diagrammatic and fragmentary views showing various different examples of protective structures in accordance with the invention for protecting the FIG. 1 passport;

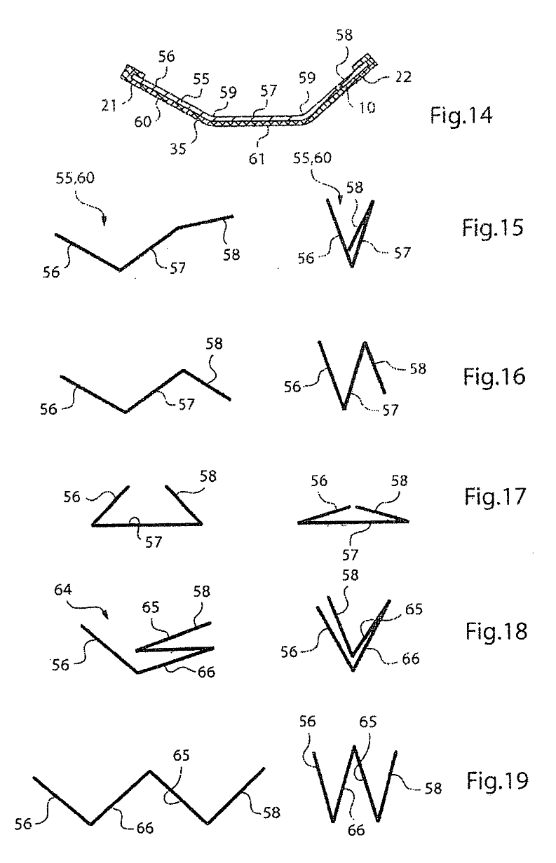

FIG. 14 is a diagrammatic and fragmentary cross-section view of an article comprising three panels protected by a protective structure of the invention;

FIGS. 15 to 19 are diagrammatic and fragmentary views showing different examples of articles having three or four panels that are folded in different ways;

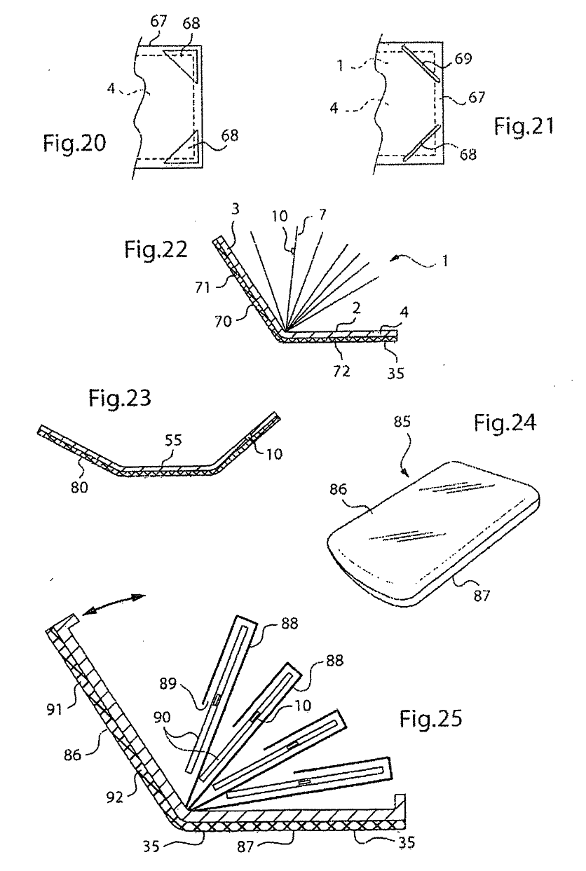

FIGS. 20 and 21 are diagrammatic and fragmentary views of protective structures comprising other embodiments of the invention;

FIGS. 22 and 23 are diagrammatic and fragmentary views of articles protected by respective protective structures permanently fastened on the articles;

FIG. 24 is a diagrammatic and fragmentary perspective view of a case arranged to receive smart cards; and

FIG. 25 is a diagrammatic and fragmentary cross-section view of the FIG. 24 case containing a plurality of smart cards.

In the drawings, for reasons of clarity, relative proportions between the various elements shown are not always complied with, the views being diagrammatic.

FIG. 1 shows a passport 1 comprising a cover 2 made up of front and rear panels 3 and 4 connected together by a fold zone 5 defining a hinge.

The passport 1 comprises a booklet made up of a plurality of leaves 7 defining pages of the passport 1.

In the example described, the front panel 3 carries an electronic device 10 of the RFID type, comprising an electronic chip 11 connected to an antenna 12.

The electronic device 10 serves to exchange data electromagnetically without contact for the purpose of reading from and/or writing to the electronic device 10 with the help of an external device.

Specifically, the electronic device 10 is incorporated in the thickness of the front panel 3, as described for example in international application WO 02/089052.

Naturally, the electronic device 10 may be incorporated in or on the article in any appropriate manner.

For example, the device 10 may be carried by a label or by a paper visa stuck on the article.

By way of example, the device 10 may be carried by a leaf 7 of the booklet.

One of the sheets may be made of paper or of plastics material.

The passport 1 may be protected by a protective structure 20 having front and rear panels 21 and 22, each being capable of being put into place on the corresponding panel 3, 4, of the passport 1, as shown in FIG. 2.

The panels 21 and 22 of the protective structure 20 are connected together by a middle fold zone 23 serving to accompany the folding of the passport 1.

As shown in FIG. 3, the panel 21 has a main portion 25 and the panel 22 has a main portion 26, each having connected thereto a respective flap 27, 28 that is folded onto the corresponding main portion 25 or 26 respectively.

The bottom and top edges 30 of each of the flaps 27 and 28 may be secured to the main portion 25 and 26 in such a manner as to enable a corresponding panel 3, 4 of the passport 1 to be inserted between a flap 27, 28 and a main portion 25, 26.

The protective structure 20 may be put into place on the passport 1 in removable manner.

In the example shown in FIG. 2, the protective structure 20 defines an electromagnetic screen 35 extending over the entire surface of the protective structure 20, i.e. over the main portions 25 and 26 and over the flaps 27 and 28.

By way of example, the protective structure 20 comprises a support of transparent plastics material, in particular of polyester, said support being metal-plated in order to form the electromagnetic screen 35.

By way of example, the protective structure 20 may present a light transmission coefficient close to 0.8, in daylight.

The main portions 25 and 26 of the panels 21 and 22 of the structure 20 are substantially transparent so that the information 9 appearing on the outside faces 28 of the cover 2 of the passport 1 is visible through these portions 25 and 26.

In a variant, the electromagnetic screen 35 may be formed by one of the following elements:
a support, in particular a film, of plastics material rolled or laminated with at least one metal film, e.g. a film of aluminum or copper forming the electromagnetic screen;
a support that is metal-plated, in particular by vacuum-plating or by chemical treatment, the support possibly being selected from: a film of plastics material; a paper; a textile; and a non-woven fabric;
a support, in particular of paper or of plastics material filled with an electrically conductive filler such as carbon black or carbon fibers, metal fibers, metal-plated fibers, metal flakes, a metal powder, or with a conductive agent such as salt;
a support made of interlocking yarns, in particular a woven fabric, a knit, a grid, with at least some of the yarns being made of an electrically conductive material, e.g. being made of wire;
a non-woven support comprising conductive fibers, e.g. metal fibers, possibly mixed with synthetic fibers;
a support, in particular a film, presenting a perforated metal structure;
a metal film;
an electrically conductive varnish or paint, e.g. based on copper, nickel, or silver;
an electrically conductive polymer such as polypyrrole, polyacetylen, and polythiophene; and
an electrically conductive adhesive.

The electromagnetic screen 35 may also be formed by at least one of the following elements:
a support, in particular a film, of plastics material rolled or laminated with at least one magnetic film;
a support with a magnetic coating, e.g. deposited under a vacuum or by chemical treatment;
a support, in particular of paper or of plastics material, filled with a magnetic filler such as ferrites;
a support, in particular a film, presenting a perforated structure of magnetic material;
a magnetic film;
a magnetic varnish or paint; and
an adhesive including magnetic particles.

As may be seen, when the passport 1 is closed, the electronic device 10 is protected on either side by the panels 21 and 22 of the protective structure, thus preventing the device 10 being read from and/or written to without contact, using an external device.

The protective structure 20 is separated from the passport 1 in order to enable data to be read from or written to the electronic device 10.

After this reading and/or writing operation, the protective structure 20 is put back into place on the passport 1.

In the example shown in FIG. 4, the electromagnetic screen 35 extends over only half of the protective structure 20, i.e. over the rear panel 22, for example.

Thus, there is no need to separate the protective structure 20 from the passport 1 in order to read and/or write from or to the electronic device 10.

For this purpose, it suffices to open the passport 1 so as to move the electronic device 10 far enough away from the rear panel 22 of the protective structure 20 so as to ensure that the electromagnetic screen 35 does not interfere with electromagnetic coupling between the device 10 and an external device.

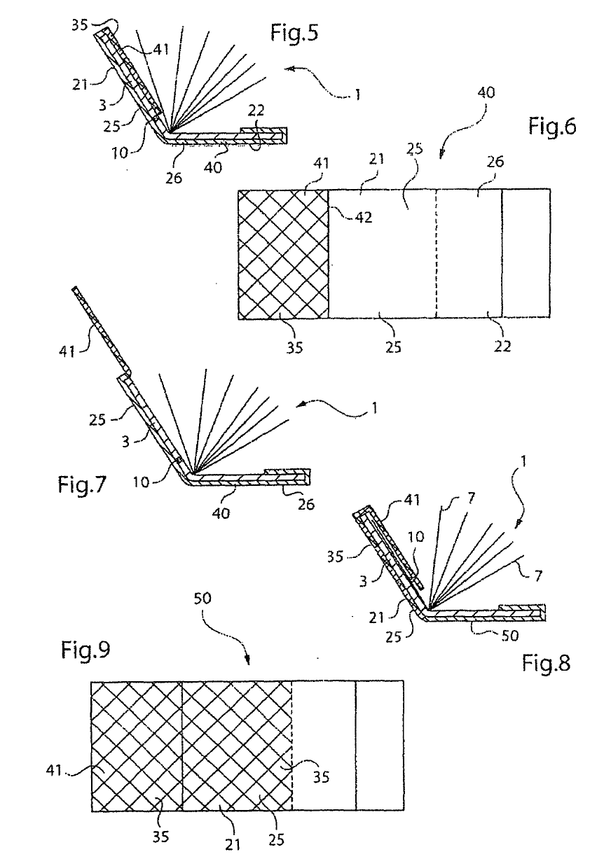

FIG. 5 shows a protective structure 40 constituting another embodiment of the invention and put removably into place on a passport 1.

This protective structure 40 differs from the above-described structure 20 by the fact that the front panel 21 of the protective structure 40 includes a flap 41 connected to the main portion 25 of the panel 21 solely via a fold zone 42 enabling said flap 41 to be folded and unfolded.

The electromagnetic screen 35 is constituted by the flap 41 alone, as shown in FIG. 6.

Thus, when the protective structure 40 is in place on the passport 1, the flap 41 may press against the panel 3 of the cover 2 of the passport 1, thereby preventing electromagnetic coupling between the device 10 carried by the panel 3 and an external device.

As shown in FIG. 7, in order to enable data to be read from the electronic device 10, the flap 41 is unfolded so as to move it away from the device 10, but without completely separating the protective structure 40 from the passport 1.

If so desired, the flap 41, which is not visible when inserted within a closed passport, may itself be substantially opaque, thus making it possible to select electrically conductive materials that are substantially opaque when making the electromagnetic screen 35.

In the example described, the flap 41 comprises a support made of a film, in particular a polyester film, laminated with an aluminum film, e.g. presenting a thickness of about 25 micrometers (μm).

In FIGS. 2 to 7, the electronic device 10 is incorporated in the front panel 3 close to the middle fold zone 23. It would not go beyond the ambit of the invention for the electronic device 10 to be incorporated on the front panel 3 in such a manner as to be situated between the front panel 21 of the protective structure and the corresponding flap.

In the example shown in FIGS. 8 to 10, the electronic device 10 is carried by a sheet 7 of the passport 1.

The passport 1 is protected by a protective structure 50 that is substantially analogous to the above-described protective structure 40 and it differs therefrom by the fact that the main portion 25 of the front panel 21 is covered by the electromagnetic screen 35.

In order to protect the device 10 against fraudulent reading and/or writing, the leaf 7 carrying the electronic device 10 is inserted under the flap 41, against the panel 3 of the passport, as shown in FIG. 8.

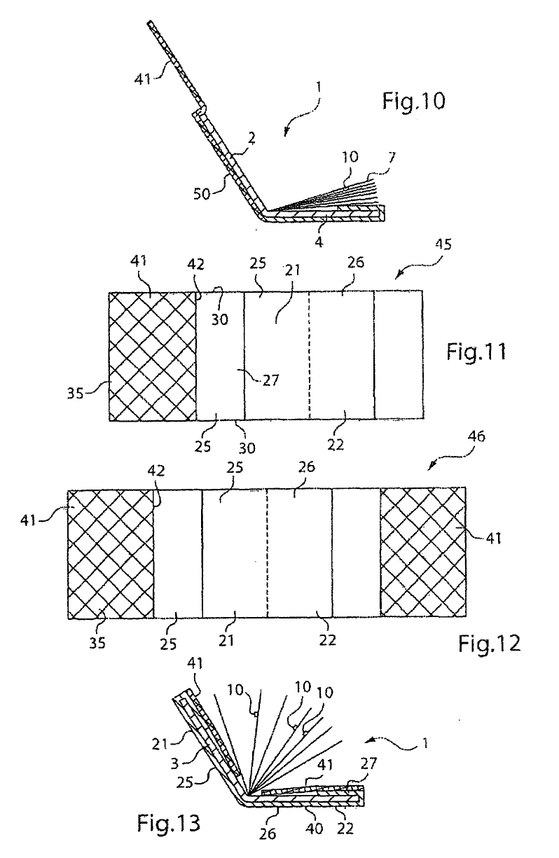

In order to enable data to be read from and/or written to the device 10, the flap 41 is unfolded and the leaf 7 carrying the device 10 is folded down against the rear panel 4 of the cover 2 of the passport 1 so as to move the device 10 away from the electromagnetic screen 35 (see FIG. 10).

FIG. 11 shows a protective structure 45 that is substantially analogous to the above-described structure 40 and that differs therefrom by the fact that the panel 21 includes not only the foldable flap 41, but also a holding flap 27 that is secured to the main portion 25 of the panel 21 via its bottom and top edges 30.

FIG. 12 shows another example of a protective structure 46 substantially analogous to the structure 45 and further including, on the panel 22, a second foldable flap 41.

The structure 46 may be used to protect a booklet, e.g. including a plurality of electronic devices 10 that are carried by different sheets of the booklet, as shown in FIG. 13. These devices 13 are sandwiched between the flaps 41 when the booklet is closed, thereby enabling these devices to be protected against fraudulent attempts at reading and/or reading.

There follows a description of examples of protective structures suitable for articles including at least three panels.

FIG. 14 shows an article 55 comprising three panels 56, 57, and 58, the outer panels 56 and 58 being connected to a central panel 57 via fold zones 59.

By way of example, the article 55 is a driving license, and it includes an electronic device 10 carried by the outer panel 58.

A protective structure 60 is put into place removably on the article 55.

The protective structure 60 is substantially analogous to the above-described protective structure 20 and differs therefrom by the fact that the protective structure 60 includes an additional central panel 61 interconnecting outer panels 21 and 22.

The electromagnetic screen 35 extends solely over the panels 21 and 61.

FIG. 15 shows the article 55 together with the protective structure 60 in the unfolded state (on the left) and in the folded state (on the right).

When the article 55 is unfolded, the electronic device 10 is far enough away from the electromagnetic screen 35, to enable the electronic device 10 to be read from and/or written to.

In the folded state, the panel 58 is sandwiched between the panels 56 and 57 such that the electromagnetic screen 35 of the protective structure 60 prevents electromagnetic coupling with the device 10.

The panels 56, 57, and 58 of the article 55 can be folded in various different ways.

As shown in FIG. 16, the panels 56, 57, and 58 may be arranged so as to enable them to be folded concertina-like. Under such circumstances, the electronic device 10 is advantageously placed on the central panel 57.

In the example shown in FIG. 17, the outer panels 56 and 58 are arranged so as to enable them to be folded down against the central panel 57.

In this example, the electronic device 10 may be placed on the central panel 57, for example, with the electromagnetic screen 35 covering the outer panels 56 and 58.

FIGS. 18 and 19 show an article 64 having four panels.

In the example shown in FIG. 18, the article 64 comprises not only the outer panels 56 and 58, but two central panels 65 and 66, the outer panels 56 and 58, and being suitable for folding against the central panels 65 and 66 respectively.

In the example shown in FIG. 19, the panels 56, 58, 65, and 66 are arranged in such a manner as to be suitable for folding in a W configuration.

In the above-described examples, the protective structure is put into place movably on the article by using holding elements each formed by a main portion and by a flap of a panel of the protective structure.

FIG. 20 shows a protective structure 67 including holding elements 68, each formed by a triangular element defining a slot enabling a corner of a panel 4 of a booklet cover to be inserted.

FIG. 21 shows holding elements for holding the protective structure on the article and comprising resilient members 69 fitted to the panels of the structure and enabling the corners of the panel 4 of the booklet cover to be held against a panel of the protective structure 67.

It would not go beyond the ambit of the present invention for the protective structure to be permanently secured to the article that is to be protected.

FIG. 22 shows a protective structure 70 having two panels 71 and 72 that are permanently fastened to the panels 3 and 4 of the cover 2 of the passport 1.

The protective structure 70 may be fastened on the panels 3 and 4 by rolling, for example, in particular by applying pressure and/or heat.

In a variant, the protective structure 70 may be fastened on the cover of the booklet 2 by adhesive, the structure 70 possibly including an adhesive layer, e.g. a layer of pressure-sensitive adhesive.

The electromagnetic screen 35 extends over the entire surface of the protective structure 70, which surface is substantially transparent in order to leave information on the cover 2 visible through said protective structure 70.

In the example shown, the electronic device 10 is carried by a leaf 7 of the passport 1.

When the passport 1 is closed, the electromagnetic screen 35 protects the electronic device 10 against attempts at reading and/or writing.

When the passport 1 is open, the leaf 7 carrying the electronic device 10 may be moved away from the panels 3 and 4 so as to enable the electronic device 10 to be coupled electromagnetically with an external device.

FIG. 23 shows a protective structure 80 analogous to the above-described protective structure 60, with the exception that the structure 80 is permanently fastened on the article 55, e.g. by rolling or by adhesive.

FIG. 24 shows a case 85 having outer panels 86 and 87, in particular panels that are substantially rigid.

Between the panels 86 and 87, the case 85 includes a plurality of pockets 88, each defining a compartment 89 for receiving a smart card 90, as shown in FIG. 25.

In the example described, a protective structure 92 is fastened on the outside faces 91 of the panels 86 and 87, e.g. by adhesive.

The protective structure 92 forms an electromagnetic screen 35 extending over the panels 86 and 87 of the case 85.

Thus, when the case 85 is closed, the electromagnetic screen 35 prevents any electromagnetic coupling between any of the electronic devices 10 and an external device.

The protective structure 92 is substantially transparent, being made for example out of metal-plated polyester, making it possible, where appropriate, to ensure that information or decoration present on the outside face of the case 85 remains visible through the protective structure 92.

The protective structure 92 serves in particular to protect the outside face 91 of the case 85.

By way of example, the case 85 may be a wallet or a piece of baggage such as an attaché case.

Naturally, the invention is not limited to the embodiments described above.

The term “comprising a” should be understood as being synonymous with “comprising at least one” unless specified to the contrary.

1. A protective structure for an article, the article comprising:
at least two panels connected together by a fold zone; and
at least one electronic device enabling data to be exchanged without contact, or at least one compartment arranged to receive at least one element including such an electronic device;
the protective structure comprising;
at least one fold zone enabling the structure to accompany folding of the article;
at least one electromagnetic screen including at least one portion that is substantially transparent so that information that appears on the article can be seen through said substantially transparent portion of the protective structure; and
at least one holding element arranged to hold the article on the protective structure in releasable manner;
the structure being arranged to be capable of taking at least one configuration in which the structure is put into place on the article and the electromagnetic screen opposes contactless reading and/or writing of the electronic device.

2. A protective structure for an article, the article comprising:
at least two panels connected together by a fold zone; and
at least one electronic device enabling data to be exchanged without contact, or at least one compartment arranged to receive at least one element including such an electronic device;
the protective structure comprising:
at least one fold zone enabling the structure to accompany folding of the article;
at least two panels connected together by said at least one fold zone, at least one of the panels of the protective structure including at least one main portion and a flap connected to the main portion of the panel so as to enable the flap to be folded towards and away from the main portion;
at least one electromagnetic screen; and
at least one holding element arranged to hold the article on the protective structure in releasable manner;
the structure being arranged to be capable of taking at least one configuration in which the structure is put into place on the article and the electromagnetic screen opposes contactless reading and/or writing of the electronic device.

3. A structure according to claim 2, arranged to cover at least part of an outside face of the article when the protective structure is put into place on the article.

4. A structure according to claim 1, having two panels connected together by said fold zone.

5. A structure according to claim 4, at least one of the panels of the protective structure including at least one main portion and a flap for forming the holding element enabling at least a portion of a panel of the article to be inserted between said main portion and said flap.

6. A structure according to claim 5, the flap having at least two opposite edges, that are fastened to the main portion of the panel.

7. A structure according to claim 5, said flap being connected to said main portion of the panel in such a manner as to enable the flap to be folded towards and away from the main portion.

8. A structure according to claim 2, the holding element comprising at least one element that is fastened to a panel of the structure.

9. A structure according to claim 8, the holding element comprising at least one resilient member arranged to hold a panel of the article against a panel of the protective structure.

10. A structure according to claim 2, the electromagnetic screen extending over the entire surface of the protective structure.

11. A structure according to claim 2, the electromagnetic screen extending over a portion only of the surface of the protective structure.

12. A structure according to claim 11, including at least one panel having a main portion for covering at least part of an outside face of the corresponding panel of the article, the electromagnetic screen extending over at least said main portion of the protective structure.

13. A structure according to claim 2, the electromagnetic screen extending at least over said flap.

14. A structure according to claim 13, having two foldable flaps, each connected to a main portion of two panels of the protective structure.

15. A structure according to claim 2, the electromagnetic screen extending both over said main portion and over said flap of the panel.

16. A structure according to claim 2, having at least three panels connected together in pairs by respective fold lines.

17. A structure according to claim 2 the electromagnetic screen being defined by a transparent portion so as to enable information that appears on the article to be visible through said transparent portion.

18. A structure according to claim 17, the transparent portion presenting a light transmission coefficient that is greater than 0.5.

19. A structure according to claim 2, including at least one support made of plastics material.

20. A structure according to claim 2, the electromagnetic screenbeing defined by an opaque portion, said portion being opaque.

21. A structure according to claim 2, the electromagnetic screen being formed with the help of at least one of the following elements:
a support of plastics material rolled or laminated with at least one metal film;
a support that is metal-plated, the support being selected from: a film of plastics material; a paper; a textile; and a non-woven fabric;
a support of paper or of plastics material filled with an electrically conductive filler;
a support made of interlocking yarns, with at least some of the yarns being made of an electrically conductive material;
a non-woven support comprising conductive fibers;
a support presenting a perforated metal structure;
a metal film;
an electrically conductive varnish or paint;
an electrically conductive polymer and an electrically conductive adhesive.

22. A structure according to claim 2, the electromagnetic screen including at least one of the following elements:
a support of plastics material rolled or laminated with at least one magnetic film;
a support with a magnetic coating;
a support filled with a magnetic filler such as ferrites;
a support presenting a perforated structure of magnetic material;
a magnetic film;
a magnetic varnish or paint; and
an adhesive including magnetic particles.

23. A structure according to claim 2, arranged to be capable of being put into place on a document.

24. A structure according to claim 2, the electromagnetic screen defining a pattern.

25. An assembly comprising:
an article; and
a protective structure as defined in claim 2 put into place removably on said article.

26. An assembly according to claim 25, the article comprising a booklet, having a cover presenting two panels.

27. An assembly according to claim 26, said at least one holding element of the protective structure being arranged to hold simultaneously one of the panels of the cover and one or more sheets of the booklet.

28. An assembly according to claim 26, the electronic device being carried by a panel of the cover of the booklet or by a sheet of the booklet.

29. An assembly according to claim 25, the article including at least three panels connected together in pairs by respective fold zones.

30. A method of protecting an article in an assembly according to claim 25, against attempts at contactless reading and/or writing from or to the electronic device, the method comprising the following step:
placing the protective structure removably into place on the article.

31. An assembly comprising:
an article comprising at least one electronic device enabling data to be exchanged electromagnetically, or at least one compartment arranged to receive at least one element including such a device; and
a protective structure arranged to be capable of taking at least one configuration in which the structure is put into place on the article and the electromagnetic screen opposes reading and/or writing data from or to the electronic device, the structure including at least one transparent portion defining at least part of the electromagnetic screen in such a manner that the information appearing on the article is visible through said transparent portion of the protective structure.
